(19) United States
(12) Patent Application Publication
(10) Pub. No.: US 2008/0089641 A1
(43) Pub. Date: Apr. 17, 2008

(54) OPTOELECTRONIC LATERAL SCANNER AND OPTICAL PROBE WITH DISTAL ROTATING DEFLECTOR

(76) Inventor: Felix I. FELDCHTEIN, Cleveland, OH (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/866,810

(22) Filed: Oct. 3, 2007

Related U.S. Application Data
(60) Provisional application No. 60/828,706, filed on Oct. 9, 2006.

(51) Int. Cl. G02B 26/10; G02B 6/26; G02B 6/32

(52) U.S. Cl. 385/26; 359/198

(57) ABSTRACT

A forward looking optical fiber probe includes an optoelectronic lateral scanner that provides circular scanning using a single pass-through optical motor and a single rotating deflector. The optical fiber is kept stationary while circular scanning is provided by an optically transparent rotating deflector intersected by the optical radiation. The arrangement allows for hermetically sealing the optical fiber probe for disinfection, sterilization and clinical use in a clean environment in general. The design is suited to be used in a miniature forward looking optical fiber probe and has a potential for advanced manufacturing and assembling process.

### CROSS-REFERENCE TO RELATED APPLICATIONS

This application is based on and claims priority to U.S. Provisional Patent Application Ser. No. 60/828,706, filed on Oct. 9, 2006, the entirety of which is incorporated herein.

### BACKGROUND OF THE INVENTION

The subject application relates generally to optical imaging. In particular, the subject application is directed to an optoelectronic lateral scanner to be used in a device for delivering optical radiation to an associated sample in optical imaging, such as, for example and without limitation, frequency domain and time domain optical coherence tomography (OCT) for providing internal depth profiles and depth resolved images of associated samples. The subject application is also directed to a device for delivering optical radiation to an associated sample, preferably implemented as a forward looking optical fiber probe including a lateral scanner, and is capable of being used in any imaging modality that requires lateral scanning.

Previously known forward looking optoelectronic lateral scanners of the type are typically used in optical fiber probes and typically include a stationary part, including a bearing support and a magnetic system, and a moving part. The moving part typically includes an optical fiber of the optical fiber probe. The optical fiber is anchored at one end to a bearing support and serves as a flexible cantilever, whereas the free end of the optical fiber is arranged such, that it can move in a direction perpendicular to its own axis. However, this arrangement becomes very complicated when a scanning pattern other than linear, is required.

Another known arrangement is based on simultaneous rotation of two deflecting elements, one of which is an optical fiber of an optical fiber probe, and the other is a refractive element placed close to the distal end of the optical fiber. The two deflecting elements are rotated about respective different axis and can provide very sophisticated scanning patterns if appropriate combinations of angular speeds and directions are used. In another arrangement, the scanner includes two refractive lenses placed at the distal end of the optical fiber, which refractive lenses are arranged to rotate about respective different axes. In this arrangement, the optical fiber is kept inside of a first tube, to which the first refractive lens is attached. The second refractive lens is attached to a second, outer tube. The two tubes are mounted to two different external motors (placed outside of the optical fiber probe) or one motor, via respective gears that provide necessary rotation of the two tubes together with the refractive elements mounted thereto. This arrangement creates evident difficulties with mechanical interfacing of the rotary tubes in the proximal part of the optical fiber probe. In addition, this arrangement creates major challenges in hermetically sealing the optical fiber probe for disinfection, sterilization and clinical use in a clean environment in general.

### SUMMARY OF THE INVENTION

In accordance with the subject application, there is provided a forward looking optoelectronic lateral scanner to be used in a device for delivering optical radiation to an associated sample in optical imaging.

Further, in accordance with the subject application, there are provided a forward looking optoelectronic lateral scanner and an optical fiber probe that allow for hermetically sealing the optical fiber probe for disinfection, sterilization and clinical use in a clean environment in general.

Still further, in accordance with the subject application, there are provided a forward looking optoelectronic lateral scanner and an optical fiber probe having a potential for advanced manufacturing and assembling process.

Further in accordance with one embodiment of the subject application, there is provided a forward looking optoelectronic lateral scanner, including an optical path for an optical radiation propagating therethrough, at least one pass-through optical motor placed in the optical path, and at least one deflecting element fixedly attached to the at least one pass-through optical motor. At least a part of the at least one pass-through optical motor is adapted for rotating about a rotation axis. At least a part of the at least one pass-through optical motor is, at least partially, optically transparent in an operating spectral range and is adapted for intersecting the optical radiation propagating therethrough. At least a part of the at least one deflecting element is, at least partially, optically transparent in the operating spectral range and is adapted for intersecting the optical radiation propagating therethrough.

In one embodiment of the subject application, the part of the at least one pass-through optical motor adapted for rotating about a rotation axis is a rotor of the at least one pass-through optical motor, wherein the at least one pass-through optical motor further includes a stator. The stator of the at least one pass-through optical motor envelopes, at least partially, the rotor of the at least one pass-through optical motor.

In another embodiment of the subject application, the forward looking optoelectronic lateral scanner further includes a stationary optical fiber adapted for forming a proximal part of the optical path for the optical radiation propagating therethrough. The at least one deflecting element fixedly attached to the at least one pass-through optical motor is positioned in a distal part of the optical path for the optical radiation propagating therethrough.

The at least one deflecting element is as at least one of a wedge, a gradient lens, an off-center regular spherical lens, or an off-center aspherical lens. In one embodiment, the at least one deflecting element is a focusing element adapted for focusing the optical radiation propagating therethrough.

Further, in accordance with one embodiment of the subject application, there is provided a forward looking optoelectronic lateral scanner comprising an optical path for an optical radiation propagating therethrough and at least one deflecting element placed in the optical path and adapted for rotating about a rotation axis. The at least one deflecting element is at least a part of a pass-through optical motor. At least a part of the at least one deflecting element is, at least partially, optically transparent in the operating spectral range and is adapted for intersecting the optical radiation propagating therethrough.

In one embodiment of the subject application, the at least one deflecting element is a rotor of the pass-through optical motor, wherein the pass-through optical motor further comprises a stator. The stator of the at least one pass-through optical motor envelopes, at least partially the at least one deflecting element.

In another embodiment of the subject application, the forward looking optoelectronic lateral scanner further comprises a stationary optical fiber adapted for forming a proximal part of the optical path for the optical radiation propagating therethrough. The at least one deflecting element is positioned in a distal part of the optical path for the optical radiation propagating therethrough.

In yet another embodiment of the subject application, the at least one deflecting element is as at least one of a wedge, a gradient lens, an off-center regular spherical lens, or an off-center aspherical lens. In one embodiment, the at least one deflecting element is a focusing element adapted for focusing the optical radiation propagating therethrough.

Still further, in accordance with one embodiment of the subject application, there is provided a forward looking optical fiber probe comprising a hollow elongated body. The forward looking optical fiber probe further includes a stationary optical fiber extending through the hollow elongated body and a forward looking optoelectronic lateral scanner. The stationary optical fiber includes a tip, wherein the forward looking optoelectronic lateral scanner is positioned in a distal part of the elongated body beyond the tip of the stationary optical fiber.

In one embodiment of the subject application, the forward looking optoelectronic lateral scanner of the forward looking optical fiber probe comprises an optical path for an optical radiation propagating therethrough, at least one pass-through optical motor, and at least one deflecting element fixedly attached to the at least one pass-through optical motor. At least a part of the at least one pass-through optical motor is adapted for rotating about a rotation axis. At least a part of the at least one pass-through optical motor is, at least partially, optically transparent in the operating spectral range and is adapted for intersecting the optical radiation propagating therethrough. The at least one deflecting element is, at least partially, optically transparent in the operating spectral range and is adapted for intersecting the optical radiation propagating therethrough. The at least one deflecting element and the at least one pass-through optical motor are positioned in a distal part of the optical path for the optical radiation propagating therethrough.

In another embodiment of the subject application, the part of the at least one pass-through optical motor adapted for rotating about a rotation axis is a rotor of the at least one pass-through optical motor. The at least one pass-through optical motor further includes a stator, wherein the stator of the at least one pass-through optical motor envelopes, at least partially, the rotor of the at least one pass-through optical motor.

In yet another embodiment of the subject application, the at least one deflecting element is as at least one of a group consisting of a wedge, a gradient lens, an off-center regular spherical lens, and an off-center aspherical lens. In one embodiment, the at least one deflecting element is a focusing element adapted for focusing the optical radiation propagating therethrough.

In yet another embodiment of the subject application, the forward looking optoelectronic lateral scanner of the forward looking optical fiber probe comprises an optical path for an optical radiation propagating therethrough and at least one deflecting element adapted for rotating about a rotation axis. The at least one deflecting element is at least a part of a pass-through optical motor and is, at least partially, optically transparent in the operating spectral range. The at least one deflecting element is adapted for intersecting the optical radiation propagating therethrough and is positioned in a distal part of the optical path for the optical radiation propagating therethrough.

In yet another embodiment of the subject application, the at least one deflecting element is a rotor of the pass-through optical motor. The pass-through optical motor further comprises a stator, wherein the stator of the at least one pass-through optical motor envelopes, at least partially, the at least one deflecting element.

In a further embodiment of the subject application, the at least one deflecting element is at least one of a wedge, a gradient lens, an off-center regular spherical lens, or an off-center aspherical lens. In one embodiment, the at least one deflecting element is a focusing element adapted for focusing the optical radiation propagating therethrough.

Still other aspects of the present invention will become readily apparent to those skilled in this art from the following description wherein there is shown and described a preferred embodiment of this subject application, simply by way of illustration of one of the best modes suited for to carry out the subject application. As it will be realized, the subject application is capable of other different embodiments and its several details are capable of modifications in various obvious aspects all without departing from the subject application. Accordingly, the drawings and description will be regarded as illustrative in nature and not as restrictive.

### BRIEF DESCRIPTION OF THE DRAWINGS

The accompanying drawings incorporated in and forming a part of the specification, illustrate the present invention, and together with the description serve to explain the principles of the invention.

FIG. 1 is a schematic diagram of an embodiment of a distal part of a forward looking optical fiber probe including a forward looking optoelectronic lateral scanner according to the subject application.

FIG. 2 is a block diagram of an exemplary embodiment of a common-path OCT device implementing a forward looking optical fiber probe of the subject application.

### DETAILED DESCRIPTION OF THE INVENTION

The subject application is directed to an optoelectronic lateral scanner to be used in a device for delivering optical radiation to an associated sample in optical imaging, such as, for example, frequency domain and time domain optical coherence tomography (OCT) for providing internal depth profiles and depth resolved images of associated samples. The subject application is also directed to a device for delivering optical radiation to an associated sample, preferably implemented as a forward looking optical fiber probe including a forward looking optoelectronic lateral scanner, and is capable of being used in any imaging modality that requires lateral scanning. The delivering device is illustrated as an optical fiber implementation, which is preferable for use in medical applications, especially in endoscopy, where flexibility of the optical fiber provides convenient access to different tissues and organs, including internal organs via an endoscope. However, the delivering device as well as the lateral scanner are capable of being implemented without the use of optical fiber.

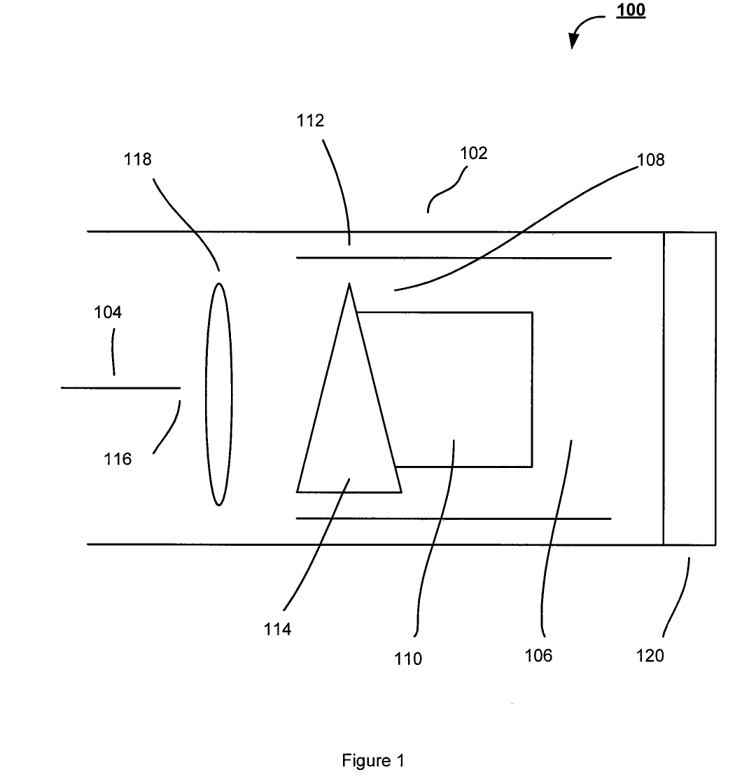

Turning now to FIG. 1, there is shown a schematic diagram of an embodiment of a distal part 100 of a forward looking optical fiber probe. As shown in FIG. 1, the distal part 100 of the forward looking optical fiber probe includes a hollow elongated body 102, such as a sheath, an optical fiber 104 and a forward looking optoelectronic lateral scanner 106. A skilled artisan will understand that the body 102 is capable of being made, for example and without limitation, of stainless steel. The optical fiber 104 is any suitable optical fiber known in the art, for example and without limitation, a single mode optical fiber. Those skilled in the art will appreciate that other types of optical fiber are capable of being used for the purpose of the subject application. The forward looking optoelectronic lateral scanner 106 includes a pass-through optical motor 108, a part of which is, at least partially, optically transparent, and a deflecting element 110. The pass-through optical motor 108 includes a stator 112, which is mechanically connected with the body 102 via any suitable means, as known in the art. The pass-through optical motor 108 further includes a rotor 114. As shown in FIG. 1, the stator 112 envelopes the rotor 114. In the embodiment depicted in FIG. 1, the deflection element 110 is fixedly attached to the rotor 114. As will be appreciated by those skilled in the art, the deflection element 110 is advantageously capable of being at least a part of the pass-through optical motor 108. For example and without limitation, the deflection element 110 is suitably capable of being the rotor 114 of the pass-through optical motor 108 (this embodiment is not shown in the drawing).

Both the rotor 114 and the deflecting element 110 are, at least partially, optically transparent and are placed such that the optical radiation emitted from the tip 116 of the optical fiber 104 intersects both the rotor 114 and the deflecting element 110. A skilled artisan will recognize that the deflecting element 110 is capable of being implemented as at least one of a wedge, a gradient lens with non-parallel front and end surfaces, an off-center regular spherical lens, an off-center aspherical lens, or a combination thereof. In one embodiment, the deflecting element 110 is advantageously a focusing element adapted for focusing the optical radiation propagating therethrough. As will be appreciated by those skilled in the art, the distal part 110 of the forward looking optical fiber probe is capable of additionally including a stationary focusing or collimating system, either optically connected with the optical fiber 104, or completely integrated into the optical fiber 104. Those skilled in the art will further recognize that focusing or collimating system is capable of being implemented, for example and without limitation, as an appropriately shaped optical fiber tip, or may have some separation from the optical fiber using fusion splicing, or glue, or other suitable known methods of attachment. Alternatively, a piece of coreless optical fiber is suitably inserted between the optical fiber 104 and the stationary focusing or collimating system, as known in the art. As will be apparent to a skilled artisan, in any case the stationary focusing or collimating system is capable of including one or more optical elements, depending on application and requirements of the optical system.

The embodiment depicted in FIG. 1 includes a stationary focusing system illustrated as a focusing lens 118 optically coupled with the tip 116 of the optical fiber 104. The embodiment of FIG. 1 further includes an optical window 120. Those skilled in the art will appreciate that the optical window 120 is, at least partially, optically transparent in the operating spectral range of the optical fiber probe of the subject application, and when the optical fiber probe is intended for use in medical applications, the optical window 120 is made of material allowed for use in medical purposes.

The forward looking optical fiber probe of the subject application is capable of being advantageously used in a common-path optical coherence tomography device. A skilled artisan will understand that in this case, a point of a reference reflection should be available in the probe optical system. Those skilled in the art will recognize that this reference reflection is suitably obtained, for example and without limitation, from the tip 116 of the optical fiber 104 (suitably coated, or angle cleaved, or angle polished to provide optimum reflection level). Alternatively, the reference reflection is suitably provided from any surface of the stationary or rotating optical element(s).

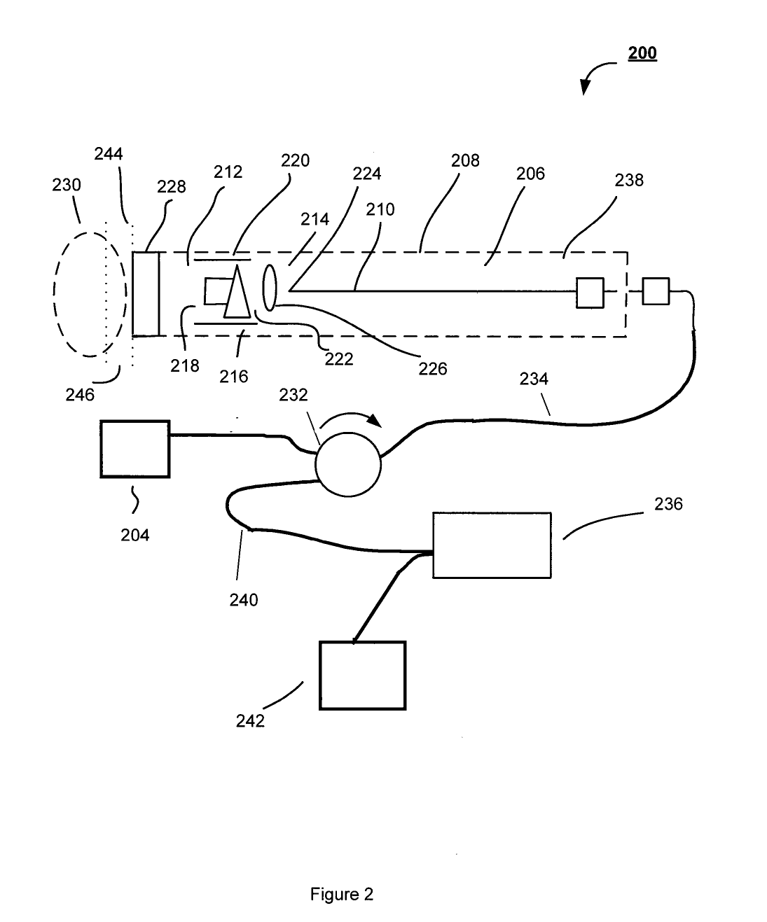

Turning now to FIG. 2, there is shown a block diagram of an example embodiment of a common path optical coherence tomography device 200 using a delivering device of the subject application. The device 200 includes a source 204 of optical radiation optically coupled with a delivering device, preferably implemented as a forward looking optical fiber probe 206. The forward looking optical fiber probe 206 includes a hollow elongated body (sheath) 208, an optical fiber 210 and a forward looking optoelectronic lateral scanner 212 located in a distal part 214 of the optical fiber probe 206. A skilled artisan will understand that the body 208 is made, for example and without limitation, of stainless steel. The optical fiber 210 is any suitable optical fiber known in the art, for example and without limitation, a single mode optical fiber.

The forward looking optoelectronic lateral scanner 212 includes a pass-through optical motor 216, which is, at least partially, optically transparent in the operating spectral range, and a deflecting element 218. The pass-through optical motor 216 includes a stator 220, which is mechanically connected with the body 208, and a rotor 222. As shown in FIG. 2, the stator 220 envelopes the rotor 222. In the embodiment depicted in FIG. 2, the deflecting element 218 is fixedly attached to the rotor 222. Both the rotor 222 and the deflecting element 218 are, at least partially, optically transparent in the operating spectral range, and are placed such that an optical radiation emitted from a tip 224 of the optical fiber 210 intersects both the rotor 222 and the deflecting element 218. A skilled artisan will recognize that the deflecting element 218 is capable of being implemented as at least one of the following: a wedge, a gradient lens with non-parallel front and end surfaces, an off-center regular spherical lens, an off-center aspherical lens, or a combination thereof.

Also included in the embodiment of FIG. 2 is a focusing lens 226 optically coupled with the tip 224 of the optical fiber 210, and an optical window 228. Those skilled in the art will appreciate that the optical window 228 is, at least partially, optically transparent in the operating spectral range, and when the forward looking optical probe is intended for use in medical applications, the optical window 228 is made of material allowed for use in medical purposes. In this embodiment, the tip 224 of the optical fiber 210 is adapted to perform a function of a reference reflector. In other words, the tip 224 of the optical fiber 210 is adapted for splitting the optical radiation delivered from the source 204 of optical radiation into two portions, one of which is further delivered to an associated sample 230 (sample portion), while the other portion of the optical radiation serves as a reference reflection.

In the embodiment illustrated in FIG. 2, the source 204 is coupled with the optical fiber probe 206 through a directional element 232 and an optical fiber 234. The device 200 also includes optical unit 236 that is in optical communication with a proximal part 238 of the optical fiber probe 206 through an optical fiber 240, the directional element 232, and the optical fiber 234. The optical unit 236 serves for further splitting the sample portion and the reference portion into two replicas and further recombining respective replicas to produce a combination optical radiation. A skilled artisan will appreciate that the optical unit 236 is capable of being implemented as any optical interferometer known in the art, for example and without limitation, as a Michelson interferometer, a Mach-Zehnder interferometer, or the like.

The common path optical coherence device further includes an optoelectronic registering unit 242 optically coupled with the optical unit 236, the optoelectronic registering unit 242 including a data processing and displaying unit (not shown).

In the embodiment depicted in FIG. 2, the tip 224 of the optical fiber 210 is placed at a predetermined optical path length from a front boundary 244 of a longitudinal range of interest 246 of the common path optical coherence device 200. The optical window 228 is placed in a vicinity of the associated sample 230.

The operation of the forward looking optoelectronic lateral scanner and of the forward looking optical fiber probe of the subject application, will be explained now with reference to the exemplary embodiment of a common-path OCT device 200 as depicted in FIG. 2. Referring now to operation of the common path OCT device 200 shown in FIG. 2, the operation of the common-path OCT device 200 commences by placing the forward looking optical fiber probe 206 such that there exists a predetermined optical path length between the tip 224 of the optical fiber 210 and the front boundary 244 of the longitudinal range of interest 246 (reference offset). Next, an optical radiation from the source 204 is directed to the directional element 232, and further through the optical fiber 234 to the proximal part 238 of the optical fiber probe 206. In a preferred embodiment, the source 204 operates in the visible or near IR range. The source 204 is, for example, and without limitation, a semiconductor superluminescent diode, doped-fiber amplified spontaneous emission superlum, solid state or fiberoptic femtosecond laser.

The forward looking optical fiber probe 206 is adapted to form and deliver an optical radiation beam to an associated sample 230. Thus, a first portion of the optical radiation beam is emitted from the partially reflecting tip 224 of the optical fiber 210 and focused by the lens element 226. Next, the first portion of the optical radiation beam is deflected by the deflecting element 218 rigidly connected with the optical pass-through rotor 222, rotating inside the stator 220. As will be appreciated by those skilled in the art, the optical radiation beam is deflected in accordance with a scanning pattern, such as a circular scanning pattern, provided by the forward looking optoelectronic lateral scanner 212. After passing the optical window 228 the optical radiation beam is delivered to an associated sample 230, and is reflected or backscattered from it (the sample portion).

Those skilled in the art will recognize that respective electrical power is suitably delivered to the stator 220 of the pass-through optical motor 216 using electrical wires (not shown). A skilled artisan will understand that the pass-through optical motor 216 is capable of being implemented as any suitable pass-through optical motor known in the art, including, for example and without limitation, an asynchronous, synchronous, step optical motor, or the like. Various optical motor design concepts and devices, including micro electromechanical devices, piezomotors, ultrasound motors and other suitable devices are advantageously capable of being used, as known in the art.

Another part of the optical radiation that enters the optical fiber probe 206 does not reach the associated sample 230, but is instead reflected at the tip 224 of optical fiber 210 of the optical fiber probe 206, at some distance from the associated sample 230 (the reference portion). The optical radiation returning from the optical fiber probe 206 is a combination of the reference and sample portions of the optical radiation, shifted axially. This combination is directed to an optical unit 236 which is adapted for suitably producing a combination optical radiation by combining part of the sample portion with a respective part of the reference portion of the optical radiation. The combination optical radiation is registered by the optoelectronic registering unit 242. As will be recognized by those skilled in the art, the optoelectronic registering unit 242 is capable of being implemented as a time domain optoelectronic registering unit, or a frequency domain optoelectronic registering unit.

A skilled artisan will understand that the optoelectronic lateral scanner and the optical probe described herein provide circular scanning using a single pass-through optical motor and a single rotating deflector. Those skilled in the art will appreciate that circular scanning instead of more sophisticated scanning patterns, or linear scanning is preferable for OCT imaging in many clinical applications. One example is visualization of highly elongated structures (for example nerves or blood vessels) for surgery guidance or other applications. In particular, it has been discovered that for nerves the cross sectional image looks different than a longitudinal aspect of the same object. Therefore, a circular scan should provide a very unique, specific OCT image, making it easy to differentiate a nerve from surrounding tissue with any random probe orientation. As will be appreciated by those skilled in the art, for providing scanning patterns other than circular, an embodiment of the subject application implementing, for example and without limitation, a second pass-through optical motor and a second deflecting element, is capable of being used. A skilled artisan will further recognize that other suitable combinations of deflecting elements are advantageously capable of implementation for providing necessary scanning patterns.

The forward looking optoelectronic lateral scanner and the forward looking optical fiber probe of the subject application are illustrated herein as being used in a common path OCT device 200 including the unit 236 implemented as a secondary interferometer, used for producing a combination optical radiation. However, a skilled artisan will appreciate, that the forward looking optoelectronic lateral scanner and the forward looking optical fiber probe of the subject application are capable of being used in any other type of a common path OCT device. Those skilled in the art will further recognize that the optoelectronic lateral scanner and the optical fiber probe of the subject application are capable of being used in any other OCT device or other imaging modality requiring lateral scanning.

The foregoing description of preferred embodiments of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A forward looking optoelectronic lateral scanner comprising:
an optical path for an optical radiation propagating therethrough;
at least one pass-through optical motor placed in the optical path, and
at least one deflecting element fixedly attached to the at least one pass-through optical motor;
wherein at least a part of the at least one pass-through optical motor is adapted for rotating about a rotation axis;
wherein at least a part of the at least one pass-through optical motor is, at least partially, optically transparent in an operating spectral range and is adapted for intersecting the optical radiation propagating therethrough; and
wherein at least a part of the at least one deflecting element is, at least partially, optically transparent in the operating spectral range and is adapted for intersecting the optical radiation propagating therethrough.

2. The forward looking optoelectronic lateral scanner of claim 1:
wherein the part of the at least one pass-through optical motor adapted for rotating about a rotation axis is a rotor of the at least one pass-through optical motor;
wherein the at least one pass-through optical motor further includes a stator; and
wherein the stator of the at least one pass-through optical motor envelopes, at least partially, the rotor of the at least one pass-through optical motor.

3. The forward looking optoelectronic lateral scanner of claim 1 further comprising:
a stationary optical fiber adapted for forming a proximal part of the optical path for the optical radiation propagating therethrough;
wherein the at least one deflecting element fixedly attached to the at least one pass-through optical motor is positioned in a distal part of the optical path for the optical radiation propagating therethrough.

4. The forward looking optoelectronic lateral scanner of claim 1 wherein the at least one deflecting element is as at least one of a group consisting of a wedge, a gradient lens, an off-center regular spherical lens, and an off-center aspherical lens.

5. The forward looking optoelectronic lateral scanner of claim 1 wherein the at least one deflecting element is a focusing element adapted for focusing the optical radiation propagating therethrough.

6. A forward looking optoelectronic lateral scanner comprising:
an optical path for an optical radiation propagating therethrough; and
at least one deflecting element placed in the optical path and adapted for rotating about a rotation axis;
wherein the at least one deflecting element is at least a part of a pass-through optical motor; and
wherein at least a part of the at least one deflecting element is, at least partially, optically transparent in the operating spectral range and is adapted for intersecting the optical radiation propagating therethrough.

7. The forward looking optoelectronic lateral scanner of claim 6:
wherein the at least one deflecting element is a rotor of the pass-through optical motor;
wherein the pass-through optical motor further comprises a stator; and
wherein the stator of the at least one pass-through optical motor envelopes, at least partially, the at least one deflecting element.

8. The forward looking optoelectronic lateral scanner of claim 6 further comprising:
a stationary optical fiber adapted for forming a proximal part of the optical path for the optical radiation propagating therethrough;
wherein the at least one deflecting element is positioned in a distal part of the optical path for the optical radiation propagating therethrough.

9. The forward looking optoelectronic lateral scanner of claim 6 wherein the at least one deflecting element is as at least one of the group consisting of a wedge, a gradient lens, an off-center regular spherical lens, and an off-center aspherical lens.

10. The forward looking optoelectronic lateral scanner of claim 6 wherein the at least one deflecting element is a focusing element adapted for focusing the optical radiation propagating therethrough.

11. A forward looking optical fiber probe comprising:
a hollow elongated body;
a stationary optical fiber comprising a tip and extending through the hollow elongated body; and
a forward looking optoelectronic lateral scanner;
wherein the forward looking optoelectronic lateral scanner is positioned in a distal part of the elongated body beyond the tip of the stationary optical fiber.

12. A forward looking optical fiber probe of claim 11 wherein the forward looking optoelectronic lateral scanner comprises:
an optical path for an optical radiation propagating therethrough;
at least one pass-through optical motor placed in the optical path, and
at least one deflecting element fixedly attached to the at least one pass-through optical motor;
wherein at least a part of the at least one pass-through optical motor is adapted for rotating about a rotation axis;
wherein at least a part of the at least one pass-through optical motor is, at least partially, optically transparent in an operating spectral range and is adapted for intersecting the optical radiation propagating therethrough;
wherein the at least one deflecting element is, at least partially, optically transparent in the operating spectral range and is adapted for intersecting the optical radiation propagating therethrough; and
wherein the at least one deflecting element and the at least one pass-through optical motor are positioned in a distal part of the optical path for the optical radiation propagating therethrough.

13. The forward looking optical fiber probe of claim 12:
wherein the part of the at least one pass-through optical motor adapted for rotating about a rotation axis is a rotor of the at least one pass-through optical motor;
wherein the at least one pass-through optical motor further includes a stator; and
wherein the stator of the at least one pass-through optical motor envelopes, at least partially, the rotor of the at least one pass-through optical motor.

14. The forward looking optical fiber probe of claim 12 wherein the at least one deflecting element is as at least one of a group consisting of a wedge, a gradient lens, an off-center regular spherical lens, and an off-center aspherical lens.

15. The forward looking optical fiber probe of claim 12 wherein the at least one deflecting element is a focusing element adapted for focusing the optical radiation propagating therethrough.

16. A forward looking optical fiber probe of claim 11 wherein the forward looking optoelectronic lateral scanner comprises:
an optical path for an optical radiation propagating therethrough; and
at least one deflecting element placed in the optical path and adapted for rotating about a rotation axis;
wherein the at least one deflecting element is at least a part of a pass-through optical motor;
wherein the at least one deflecting element is, at least partially, optically transparent in the operating spectral range and is adapted for intersecting the optical radiation propagating therethrough; and
wherein the at least one deflecting element is positioned in a distal part of the optical path for the optical radiation propagating therethrough.

17. A forward looking optical fiber probe of claim 16:
wherein the at least one deflecting element is a rotor of the pass-through optical motor;
wherein the pass-through optical motor further comprises a stator; and
wherein the stator of the at least one pass-through optical motor envelopes, at least partially, the at least one deflecting element.

18. The forward looking optical fiber probe of claim 16 wherein the at least one deflecting element is as at least one of a wedge, a gradient lens, an off-center regular spherical lens, or an off-center aspherical lens.

19. The forward looking optical fiber probe of claim 16 wherein the at least one deflecting element is a focusing element adapted for focusing the optical radiation propagating therethrough.
